(19) United States
(12) Patent Application Publication
(10) Pub. No.: US 2010/0090465 A1
(43) Pub. Date: Apr. 15, 2010

(54) Process of installing prefabricated sections of pressurized and/or non-pressurized fluid-, utility-, and/or matter-carrying and encapsulated mediums with turbine systems attached into medium systems

(76) Inventor: Robert Eric Heidel, Oak Ridge, TN (US)

Correspondence Address: Robert Eric Heidel, 896 West Outer Drive, Oak Ridge, TN, 37830, US

(21) Appl. No.: 12/587,729

(22) Filed: Oct. 13, 2009

Related U.S. Application Data
(60) Provisional application No. 61/196,066, filed on Oct. 15, 2008.

(51) Int. Cl. H02K 7/18

(52) U.S. Cl. 290/52

(57) ABSTRACT

This patent pertains to an embodiment for a process for installing prefabricated sections of fluid-, utility-, and/or matter-carrying medium systems with turbines systems attached to change the kinetic energy of flowing fluids, utilities, and/or matter into electrical energy. Sections of existing or yet to be discovered mediums systems will be removed and replaced with prefabricated sections with varying turbine systems attached. These prefabricated systems can be installed in isolation or in groups along the entirety of a medium system to maximize potential electrical energy production. A system for conducting the newly generated electricity to desired destinations is also described. The patent uses the resource of infinite consumer demand for fluids, utilities, and/or matter to be transported to and from geographical areas via medium systems to generate electricity. This untapped resource of infinite consumer demand has the potential to be a beneficent “green” power source that can put power back into the grid in a clean and efficient manner.

### CROSS-REFERENCE TO RELATED APPLICATION

U.S. Provisional Application #61/196,066, Process of installing prefabricated sections of pressurized and/or non-pressurized fluid-, utility-, and/or matter-carrying and encapsulated mediums with turbine systems attached into existing and yet to be discovered medium systems

### FEDERALLY SPONSORED RESEARCH

None

### SEQUENCE LISTING

None

### BACKGROUND OF INVENTION

1. Field of Invention

The present invention pertains to a process of generating electricity by installing prefabricated sections of pressurized and/or non-pressurized fluid-, utility- and/or matter-carrying and/or encapsulated mediums with turbine systems that will generate electricity from the kinetic energy inherent in the flowing of fluids and matter through said pressurized and/or non-pressurized fluid-, utility-, and/or matter-carrying and/or encapsulated mediums.

2. Discussion of Prior Art

Heidel (U.S. Pat. No. 7,190,088) designed a process for fabricating and retrofitting turbine systems directly into existing and new medium systems to generate electricity. There are many known processes for the generation of electricity for use of the public and private sector. Hydroelectric, nuclear, wind, solar, geothermal, and fossil-fuel burning processes of generating electricity are all utilized with nuclear and fossil-fuel processes accounting for over 90% of all power generation. Some of the aforementioned processes are harmful to the environment and in most cases obsolete in terms of the advanced technology in today's society. There is a social and political movement in society today pushing for the creation and utilization of new “green” processes for the generation of electricity. Billions of dollars have been poured into researching and creating new means for generating electricity that are more environmentally safe or “green.” This patent disclosure will present a “green” process of generating electricity by attaching prefabricated sections of fluid- and/or matter-carrying mediums with turbine systems attached into both existing and new fluid- and/or matter-carrying medium systems. A brief synopsis of the aforementioned generation processes will be given and how this new system will be more productive and useful as compared to them.

Fossil fuel and steam turbines have been around for a long time and for the most part are obsolete in terms of technology and the most harmful to the environment. They work by either burning fossil fuels such as gas or coal that cause a turbine to turn which generates electricity. Noxious chemicals are released into the atmosphere which pollutes the air. The earth itself is plundered for its finite natural resources. Nuclear processes constitute creating a controlled nuclear chain reaction that produces heat which boils water causing steam to rise and turn a turbine. These processes create harmful by-products and can cause catastrophic damage to the environment if a chain reaction were to get out of control. These two forms of electricity generation are costly in the business sense as well as dangerous to the environment.

Now we turn to the more “green” processes of electricity generation. Wind turbines capture the kinetic energy of wind and turn it into either mechanical or electrical energy. This process is environmentally safe and is starting to be used by many countries but only accounts for one percent of all power generation in the world. Solar means of electricity generation use photovoltaic modules to covert energy from the sun into electricity. The main issue with solar power is the cost involved in manufacturing and installing an array of photovoltaic modules to generate electricity that would meet the demands of today's society. Geothermal processes for electricity generation deal with steam let off from water that is heated by magma or the high temperature caused by geothermal activity below the earth's surface. There is concern for what negative effects are inherent in injecting water into dry rock below the earth's surface that has never had water in it as well as the release of dangerous chemicals such as sulfur, carbon dioxide, and nitric oxide that exists in the earth's crust into the atmosphere. Hydroelectric power generation occurs mostly in large dams where water in a reservoir at a high elevation is allowed to flow into a dam where the kinetic energy of the flowing water being pulled down by gravity turns a turbine. This is by far the most utilized “green” process of generating electricity. Yet, in periods of drought water levels fall and also dams cannot at times handle the demand and load issues of consumers.

There are positive and negative attributes of all the “green” processes of electricity generation mentioned above. Scientists, researchers, and academics are constantly trying to find new resources and processes for generating electricity that has little effect on the environment. There is a need for new “green” processes for generating electricity as consumer demand rises, existing processes become obsolete, and finite resources are being used up to meet these demands. Pollution and wasteful by-products of some processes continue to put a strain on both the environment and the people who live in it. Some of the “green” processes are not cost-effective in terms of manufacturing and implementation and also cannot meet demand of consumers. This patent disclosure will describe a process that will generate electricity using an untapped resource of kinetic energy that is “green” and is powered by consumer demand for fluids, matter, utilities to be moved from one place to another. Since consumer demand is an infinite resource of kinetic energy and thereby an infinite source of potential electricity generation, this untapped resource's potential is limitless. It also will provide a means for the installation and prefabrication of sections of fluid-, utility-, and/or matter-carrying and/or encapsulated mediums with turbine systems attached. Also, a description of ways to capture the most kinetic energy from the flowing of fluids, matter, and utilities through said mediums using turbines within the sections of prefabricated and installed mediums will be presented.

### Objects and Advantages

Accordingly, the process of installing prefabricated sections of fluid-, utility-, and/or matter-carrying systems with turbine systems attached has many advantages over past “green” processes for generating electricity in that:
(a) The process can be implemented into existing medium systems which can allow for generated electricity to be put directly into a power grid
(b) The process can be implemented in isolation or along the entirety of a medium system to maximize potential electrical energy generation
(c) The process utilizes a previous untapped infinite resource of consumer demand for fluids, utilities, and/or matter to be transported in pressurized, non-pressurized, and encapsulated medium systems
(d) The process allows for turbines to be attached to several generators which can double the potential electrical power generation
(e) The process has several different potential designs for implementing turbine systems into medium systems
(f) The process allows for periods of low consumer demand for fluids, utilities, and/or matter to flow through medium systems to generate electrical energy
(g) The process could potentially replace entire medium systems to maximize potential electrical energy generation
(h) The process is a “green” process for generating electricity that could potentially benefit consumers by low costs and the environment by no harmful by-products

### SUMMARY

This invention will cover implementing, manufacturing, and installing of prefabricated sections of mediums with turbine systems already manufactured and attached into medium systems. The system allows for the generation of electricity from untapped resources and is powered by the demand for utilities, fluids, and matter to be moved from one place to another. These prefabricated sections will have the turbine systems installed to the sections upon being manufactured. This manufactured section of fluid-, utility-, and/or matter-carrying and/or encapsulated medium would then be installed into a new system of fluid-, utility-, and/or matter-carrying and/or encapsulated mediums or an existing system. There are a number of ways to manufacture the prefabricated sections of fluid-, utility-, and/or matter-carrying and/or encapsulated mediums with turbine systems so as to generate electricity. There are many different ways to install the prefabricated sections into a new or existing fluid-, utility-, and/or matter-carrying and/or encapsulated system. The goal of such a system is to generate electricity while minimizing pressure loss of the flowing fluids, utilities, and/or matter within the medium. For this reason, numerous ways of introducing turbine systems into and around the mediums is needed. There is also a need to create the means of installing the prefabricated sections of fluid-, utility-, and/or matter-carrying and/or encapsulated mediums with turbine systems attached to existing and new medium systems that makes practical sense and will have the potential to generate the most electricity.

### BRIEF DESCRIPTION OF DRAWINGS

FIG. 1A. The figure depicts a section of a fluid-, utility-, and/or matter-carrying and/or encapsulated medium that has been removed from a medium system being replaced with a prefabricated section of medium with turbine systems manufactured and attached to the section. This prefabricated section will generate electricity by capturing the kinetic energy of fluids, utilities, and/or matter flowing through the medium and change it to electrical energy. This implementation of multiple turbine systems to a medium will maximize the amount of electricity that can be generated within a medium.

FIG. 1B. The figure depicts the prefabricated section of medium with turbine systems manufactured and attached to it after it has been installed into the medium system and sealed.

FIG. 1C. The figure depicts the inside of the medium with the turbine systems attached. There are four turbines and eight generators in the depiction which shows that electrical generation potential is maximized by using multiple turbine systems attached to a prefabricated section of a pressurized/non-pressurized fluid-, utility-, and/or matter-carrying medium.

FIG. 1D. The figure is a depiction of each turbine system attached to a medium with more of an up-close view.

FIG. 1E. The figure depicts the prefabricated section of medium being installed in isolation or at longer intervals along a medium system.

FIG. 1F. The figure depicts prefabricated sections of medium being installed in groups or at much shorter intervals along the entirety of a medium system.

FIG. 2A. The figure depicts another design of a section of a pressurized/non-pressurized fluid-, utility-, and/or matter-carrying and/or encapsulated medium that has been removed from a medium system being replaced with a prefabricated section of medium with turbine systems manufactured and attached to it.

FIG. 2B. The figure depicts a section of a fluid-, utility-, and/or matter-carrying and/or encapsulated medium that has been removed from a medium system and is being replaced with a prefabricated section of medium with turbine systems manufactured and attached to it and sealed.

FIG. 2C. The figure depicts the inside of the medium with turbines manufactured inside of the medium itself.

FIG. 2D. The figure is a depiction of each turbine system attached to a medium with more of an up-close view.

FIG. 2E. The figure depicts the prefabricated section of medium being installed in isolation or at longer intervals along a medium system.

FIG. 2F. The figure depicts prefabricated sections of medium being installed in groups or at much shorter intervals along the entirety of a medium system.

FIG. 3A. The figure presents a better depiction of the mounting apparatuses. This is a critical aspect of changing the kinetic energy of flowing fluids, utilities, and/or matter to electrical energy.

FIG. 3B. The figure presents a better depiction of the mounting apparatus for the design of placing turbines entirely inside of a medium.

FIG. 3C. The figure presents a depiction of how the inside of the mounting apparatus is grooved as well as the part of the turbine shaft that passes through the mounting apparatus is grooved. This is an important part of the design because fluids, utilities, and/or matter must not be allowed to enter the generator housing.

FIG. 3D. The figure presents a depiction of how the inside of the mounting apparatus is grooved as well as the part of the turbine shaft that passes through the mounting apparatus is grooved when turbines are located completely inside of the medium.

FIG. 4. The figure is a depiction of how this technology could be utilized when demand is low for pressurized/non-pressurized utilities, fluids, and/or matter to travel from one place to another.

FIG. 5. The figure is a depiction of an embodiment of an example of how the process could potentially be implemented into a medium system.

### DRAWINGS—List of Numerals

101—Section of a fluid-, utility-, and/or matter-carrying and/or encapsulated medium (first turbine system design)
102—Prefabricated section of a fluid-, utility-, and/or matter-carrying with turbine systems attached (first turbine system design)
103—Multiple turbines and multiple generators attached to a prefabricated section of medium (first turbine system design)
104—Turbine housings (first turbine system design)
105—Generator housings (first turbine system design)
106—Wire-carrying mediums (first turbine system design)
107—Tube (first turbine system design)
201—Prefabricated section of fluid-, utility-, and/or matter-carrying medium after installation into a medium system (first turbine system design)
202—Sealing of the prefabricated section to the medium system (first turbine system design)
301—Mounting apparatuses (first turbine system design)
302—Turbine shaft attached to generator (first turbine system design)
303—Wires attached to the generator going through tube into the wire-carrying medium (first turbine system design)
304—Generator housings attached to turbine housings (first turbine system design)
305—View of generators inside of generator housings (first turbine system design)
306—View of wire-carrying mediums with wires conducting electricity to a desired destination (first turbine system design)
307—View of turbine blades protruding into a medium (first turbine system design)
308—View of turbines linked to two generators (first turbine system design)
309—Prefabricated sections of medium being installed in isolation or a longer intervals along a medium system (first turbine system design)
310—View of wire-carrying mediums transporting wires from generators to a desired destination (first turbine system design)
311—Any potential desired destination (first turbine system design)
312—Prefabricated sections of medium being installed in groups or at much short intervals along a medium system (first turbine system design)
313—Wire-carrying mediums connected from prefabricated section of medium to other prefabricated sections of mediums (first turbine system design)
314—View of potential amount of generators (first turbine system design)
315—View of number of potential wire-carrying mediums (first turbine system design)
401—Removal of a section of a medium system (second turbine system design)
402—Installment of a prefabricated section of medium with turbine systems attached (second turbine system design)
403—Generator housings (second turbine system design)
404—Wire-carrying mediums (second turbine system design)
501—Installment of a prefabricated section of medium with turbine systems attached (second turbine system design)
502—Sealing of the prefabricated section of medium to the medium system (second turbine system design)
601—View of turbines located inside of a medium (second turbine system design)
602—Mounting apparatus (second turbine system design)
603—Generator housings with generators inside (second turbine system design)
604—Tube (second turbine system design)
605—Wires leaving the generator housing and going into the wire-carrying medium (second turbine system design)
606—Prefabricated sections of medium being installed in isolation or at longer intervals along a medium system (second turbine system design)
607—View of wire-carrying mediums transporting conduction wires to desired destinations (second turbine system design)
608—Any kind of desired destination (second turbine system design)
609—Prefabricated sections of medium being installed in groups or at much shorter intervals along a medium system (second turbine system design)
610—Potential number of generator and generator housings (second turbine system design)
611—Connection of wire-carrying mediums between prefabricated sections of medium (second turbine system design)
612—Potential number of wire-carrying mediums (second turbine system design)
701—Closer view of mounting apparatuses (first turbine system design)
702—Turbine shaft (first turbine system design)
703—Connection to a generator (first turbine system design)
704—View of mounting apparatuses supporting and aligning the turbine shaft (second turbine system design)
705—View of generator housing located outside of the medium (second turbine system design)
706—Turbine blades designed to reduce pressure lost (second turbine system design)
801—Grooves of the mounting apparatus (first turbine system design)
802—Grooves of the turbine shaft (first turbine system design)
803—View of the turbine (first turbine system design)
804—View of generator (first turbine system design)
805—View of inside of mounting apparatus (second turbine system design)
806—View of part of the turbine shaft (second turbine system design)
807—View of turbine (second turbine system design)
808—View of turbine shaft connecting to generator (second turbine system design)
901—Representation of fluids, utilities, and/or matter traveling through a medium
902—Representation of low consumer demand for fluids, utilities, and/or matter to travel through a medium
903—Routing of fluids, utilities, and/or matter
904—Medium system with prefabricated sections designed to generate electricity during periods of low consumer demand
905—Identify medium systems that have potential to generate electricity
906—Specifications of all turbine system components and the medium system
907—Assemble needed components to manufacture the medium system with turbines attached
908—Remove section of existing medium system
909—Manufacture section of medium system with turbine systems attached
910—Install the manufactured and/or prefabricated section of medium into medium systems
911—Kinetic energy of flowing fluids, utilities, and/or matter changed to electrical energy
912—Newly generated electrical energy is conducted to desired destination
913—Consumer pays for electricity put into the grid by their demand for fluids, utilities, and/or matter to travel through medium systems

### Description of Specific Embodiment

The present invention, in accordance with one embodiment pertains to the manufacture, design, implementation, and installation of prefabricated sections of pressurized/non-pressurized fluid-, utility-, and/or matter-carrying and/or encapsulated mediums with turbine systems attached into new and existing utility-, fluid-, and/or matter-carrying and/or encapsulated systems. In this new process, the kinetic energy of flowing utilities, fluids, and matter through mediums will be captured by impinging upon turbines which will in turn generate electricity. This process allows for the infinite demand of consumers to have utilities, fluids, and matter moved from one place to another by various existing and yet to be discovered medium systems to become an infinite resource for generating electricity. Rather than utilizing existing electricity generating processes that are environmentally unsafe, responsible for the depletion of finite resources, costly, and obsolete, this invention provides a means of generating electricity through environmentally safe or “green” means using cost-effective fabrication and installation techniques while tapping into a new infinite resource that is consumer demand for pressurized and/or non-pressurized fluids, utilities, and matter to be carried to and from geographical locations.

The process beings with the manufacture of the sections of pressurized, non-pressurized, and/or encapsulated medium systems with turbine systems attached. This disclosure is meant to be vague in terms of coverage by saying turbine systems can be attached to any sort of pressurized/non-pressurized fluid-, utility-, and/or matter-carrying and/or encapsulated medium. These mediums could include but are not limited to water mains, water towers, sewage lines, aqueducts, utility lines, steam pipes, oil pumps, rain water vents, hydraulic systems, water systems, mechanical devices, fluid and/or matter displacement devices and apparatuses, encapsulated mediums, fluid and/or matter collection structures and apparatuses, fluid and/or matter pressure systems, water pumps, water hoses, gas lines, and all varying kinds of pipes and pipelines that carry fluids, matter, and utilities to and from homes, buildings, structures, and businesses as well as the pipes and pipelines within and outside of those homes, buildings, structures, and businesses that exist or yet have been discovered. So, in turn, this process could be manufactured and implemented into any sort of pressurized/non-pressurized fluid-, utility-, and/or matter-carrying and/or encapsulated medium. Depending on the sort of medium that the process could be utilized with, the manufacturing of the section with turbines would depend on the kind of fluid, utility, or matter that would be flowing inside of the medium itself. The sizes, shapes, makes, dimensions, utilizations, pressure limitations, and designs of varying kinds of mediums will need to be taken into consideration. The prefabricated sections of mediums would be manufactured to the exact extent of the aforementioned specifications with the exception of the addition of turbines systems being attached to the sections.

Turbines of varying designs, utilizations, shapes, materials, makes, sizes, models, dimensions, and dispositions within the medium will be implemented into the sections contingent upon the particular specifications of the mediums themselves for maximizing the potential of electricity that can be generated from the use of this technology on all varying sorts of pressurized and/or non-pressurized fluid-, utility-, and/or matter-carrying and/or encapsulated mediums. The blades of the turbines that capture the kinetic energy of flowing utilities, fluids, and/or matter through the mediums can be of varying designs, shapes, materials, makes, models, dimensions, sizes, and dispositions within the medium itself and will be determined contingent upon the particular specifications of the medium, the amount of pressure or lack thereof, the head, and the utilities, fluids, and/or matter that flow through them so as to maximize the potential of capturing the kinetic energy of utilities, fluids, and/or matter flowing through all varying sorts of pressurized and/or non-pressurized fluid-, utility-, and/or matter-carrying and/or encapsulated mediums. The turbines and the turbine blades will be positioned in varying degrees within the fluid-, utility-, and/or matter-carrying and/or encapsulated medium so that the utilities, fluids, and/or matter flowing through them will impinge upon the turbines and the turbines blades as well as in a manner that will limit the amount of pressure or head that is taken away from the flowing fluids, utilities, and/or matter traveling through said medium system.

The prefabricated sections of pressurized and/or non-pressurized fluid-, utility-, and/or matter-carrying and/or encapsulated mediums will have turbines with all their aforementioned design aspects positioned at varying increments and orientations around the circumference, inner wall, and/or outer wall of the medium itself and will be determined contingent upon the particular specifications of the mediums and the utilities, fluids, and/or matter that flow through them so as to maximize the potential of capturing kinetic energy of the utilities, fluids, and/or matter flowing through said mediums. The actual length of the prefabricated sections of pressurized and/or non-pressurized fluid-, utility-, and/or matter-carrying and/or encapsulated mediums can vary depending upon the space needed to assemble the turbine systems to the medium and the amount of space needed to properly and efficiently install the prefabricated section to the new or existing medium system.

There are many different configurations for attaching the turbine systems to the mediums. Different configurations have varying designs in terms of the components that go into making the system. Essentially, each turbine system that is attached to the medium is comprised of but not limited to several components: A turbine, turbine blades, a turbine shaft, a turbine housing, turbine mounting apparatuses, a generator(s), a generator housing(s), conduction wires, a conduction wire-carrying medium(s), connection mediums, and openings. All of these aforementioned components may or not be needed according to the specific design of the system that is prefabricated and manufactured with the medium. There can be one turbine system manufactured into a section of medium at any point around the circumference or outer wall or there can be multiple turbine systems manufactured into a section of medium around the circumference or outer wall of the medium. There can be turbine systems manufactured within the inner space of a medium.

A turbine that consists of turbine blades and a turbine shaft is placed into a turbine housing. The turbine is held in place inside of the turbine housing by use of mounting apparatuses that support the turbine shaft and align the turbine shaft with the generator(s) in the generator housing(s). The mounting apparatuses have a dual role of supporting and aligning the turbine as well as a means of keeping fluids, utilities, and/or matter out of the generator housing. The keeping of fluids, utilities, and/or matter out of the generator housing is of paramount importance within this process. To keep fluids, utilities, and/or matter from entering the generator housing, the mounting apparatuses that both supports the turbine and aligns the turbine shaft with a generator(s) as well as connects the turbine housing to the generator housing will be manufactured to varying extents and in proportional equivalency to the section of the turbine shaft that passes through it into the generator housing(s) so that the potential for fluids, utilities, and/or matter to enter said housing(s) will be extinguished.

This disclosure is meant to be vague in terms of coverage by saying that there are many possible ways of designing the mounting apparatuses and the turbine shaft so that both the turbine is supported and fluids, utilities, and/or matter is not allowed to enter the generator housing. One such embodiment could possibly be but is not limited to manufacturing the turbine shafts as well as the mounting apparatuses with grooves so that these grooves act as a barrier and seal for fluids, utilities, and/or matter not to pass into the generator housing.

The turbine housing has the role of containing the turbine and the mounting apparatuses as well as not allowing any utilities, fluids, and/or matter to escape the medium while the flowing utilities, fluids, and/or matter impinge upon the blades of the turbine. The turbine housings can be manufactured using any relevant shapes, sizes, makes, dimensions, materials, designs, and dispositions that exist or yet have been discovered and will be contingent upon the type of turbine being used and its particular specifications, the kind of medium it is attached to, the medium's specifications, the pressure and/or lack of pressure in the medium, and the orientation and placement of the turbine system in regards to other possible turbine systems around the circumference of the medium, and the particular design of the prefabricated section of medium with turbine systems attached.

The generator housing contains the generator and conduction wires as well as in some cases part of the mounting apparatuses that allow for the turbine blade to connect to the generator and keep fluids, utilities, and/or matter out of the generator housing. The generator housing(s) can be manufactured using varying sizes, shapes, dimensions, utilizations, materials, specifications, and dispositions that exist or yet have been discovered and will be contingent upon the type of generator being used and its particular specifications, the kind of medium it is attached to, the medium's specifications, and the orientation and placement of the turbine system in regards to other possible turbine systems around the circumference of the medium, and the particular design of the prefabricated section of medium with turbine systems attached.

As fluids, utilities, and/or matter impinge upon the blades of the turbine causing it to turn, the connection of the turbine shaft to the generator changes the kinetic energy of the flowing fluids, utilities, and/or matter into electrical energy. Conduction wires connected to the generator conduct this newly generated electricity to a desired destination. These conduction wires can be any sort of wire that exists or that is newly discovered that will conduct the generated electricity to a desired destination.

These conduction wires that carry the newly generated electricity to its desired destination are carried to that desired destination with or without the means of a conduction wire-carrying medium. This medium is attached to the generator housing via a smaller connection medium that allows the conduction wires to enter the wire-carrying medium and travel to its desired destination. These wire-carrying mediums and smaller connection mediums can be manufactured using any sort of existing material or one that has not been discovered yet and can vary in terms of shapes, sizes, dimensions, models, materials, dispositions, and utilizations. The particular specifications of the conduction wire-carrying medium will depend upon the kind of conduction wires being used to conduct the newly generated electricity, the number of conduction wires needing to be transported according the implementation of turbine systems along a medium system, and the insulation and grounding of the conduction wires. These wire-carrying mediums may or may not be positioned above the generator housing and could be oriented closer to the medium itself. These wire-carrying mediums may or may not need to be connected to each other if they run along the entirety of a medium system. The design, implementation, and installation of the wire-carrying mediums would depend upon the kind of medium being utilized, its specifications, the number of turbine systems installed into a medium section or medium system, the number of conduction wires needed to be transported, and practical application of the technology. The wire-carrying mediums may or may not need to be used if some other sort of process that exists or has yet been discovered could better transport the newly made electricity to its desired destination.

The desired destination mentioned above could be a number of places such as but not limited to an inverter, converter, battery, power substation, power grid, power storage unit, and/or any sort of home, business, structure, and business that exists or has yet been discovered.

Once the sections of pressurized/non-pressurized fluid-, utility-, and/or matter-carrying and/or encapsulated mediums have been manufactured, the installation into existing or new utility-, fluid-, and/or matter-carrying and/or encapsulated medium systems will occur. These prefabricated sections of mediums can be placed at varying intervals along the entirety of utility-, fluid-, and/or matter-carrying and/or encapsulated system. In some instances, whole medium systems could be replaced with prefabricated mediums with turbine systems attached if it would be more feasible to do so. In other instances, at times where demand is not at its peak, fluids, utilities, and/or matter could be rerouted into a special medium system with the technology implemented so that even when consumer demand is low, electricity could be made. The prefabricated sections could be installed but are not limited to being installed in isolation, groups, where pressure and head are greatest, where the least pressure and head will be lost, where line loss would be minimal in the conduction wires, near new or existing commercial and/or private developments (businesses, homes, structures, and buildings), far from new or existing commercial and/or private developments, at high elevations and low elevations, into new and existing utility-, fluid-, and or matter-carrying and/or encapsulated systems, systems that have yet to be discovered, mediums that exist above and below ground, inside mechanical devices and machines, power producing structures, in close and far proximity to power plants, storage units, batteries, inverters, converters, power grids, power substations, and reservoirs.

In terms of installing the prefabricated sections to existing and/or new pressurized and/or non-pressurized fluid-, utility-, and/or matter-carrying and/or encapsulated medium systems, installation would occur by stopping the flowing of fluids, utilities, and/or matter through the medium, removing a section of the existing medium and replacing it with the newly prefabricated section that has turbine systems attached. These sections of medium could be removed through any existing process of removal or one that does not exist as of yet. In the case of installing the technology into a new medium system or a type of medium system that has not been discovered yet, the prefabricated sections of medium are implemented into the system at varying degrees according to the specifications of that medium system and the potential for generation electricity within that medium system. The new section is then attached and sealed to the medium system and fluids, utilities, and/or matter and then the utilities, fluids, and/or matter is allowed to flow again. There are many possible ways after installation to seal and/or attach the prefabricated section with the existing medium system and that will be contingent upon the nature of the medium itself and its own specifications. These ways of sealing and/or attaching the prefabricated section to the medium system could be but are not limited to bonding, molding, the use of all forms of adhesives, welding, the use of all forms of sealants, the complete replacement of an existing medium system with a new medium system with turbine systems attached, and/or any kind of sealing and/or attaching process that exists or has yet been discovered.

Possibly, if many prefabricated sections of pressurized and/or non-pressurized fluid- and/or matter carrying mediums are installed into an existing or new medium system, it will be necessary to seal and/or attach the aforementioned wire-carrying mediums together. Once again, the process of sealing and/or attaching these wire-carrying mediums together could be done by but not limited to bonding, molding, the use of all forms of adhesives, welding, the use of all forms of sealants, the complete replacement of an existing medium system with a new medium system with turbine systems attached, and any kind of sealing and/or attaching process that exists or has yet been discovered.

After installation, the fluids, utilities, and/or matter are allowed to flow through the medium once again and electricity will be made through the kinetic energy of said fluids, utilities, and/or matter impinging upon the turbine blades. After the kinetic energy is changed to electrical energy by the generator, the newly generated electricity will travel via the conduction wires to a desired destination. Upon installation, the conduction wires will be implemented into and/or linked to whatever desired destination is it designated to go. This implementation and/or linkage of the newly generated electricity to the desired destination could be done in many ways that exist or have yet been discovered. These implementation and linkage processes will be situated in the above stated “desired destinations” that exist or yet have been discovered.

The operation of this new technology will now be summarized. Sections of new and/or existing pressurized and/or non-pressurized fluid-, utility-, and/or matter-carrying and/or encapsulated mediums are prefabricated and manufactured with turbine systems attached. These sections are installed, sealed, and/or attached into new and/or existing medium systems. Fluids, utilities, and/or matter flow through these medium systems and the attached turbine systems capture the kinetic energy of the flowing fluids, utilities, and/or matter. The kinetic energy is changed to electric energy by a generator. The newly generated electricity travels to a desired destination by means of conduction wires that are attached to the generator. These conduction wires are housed in insulated wire-carrying mediums. The conduction wires are implemented and/or linked to the desired destination and then the newly generated electricity is usable by all consumers. Consumers are then charged a fee for the purchase of electricity they have generated by their demand. By consumer demand for utilities, fluids, and/or matter to be moved from one place to another by mediums, electricity will be generated, purchased, and utilized by those same consumers.

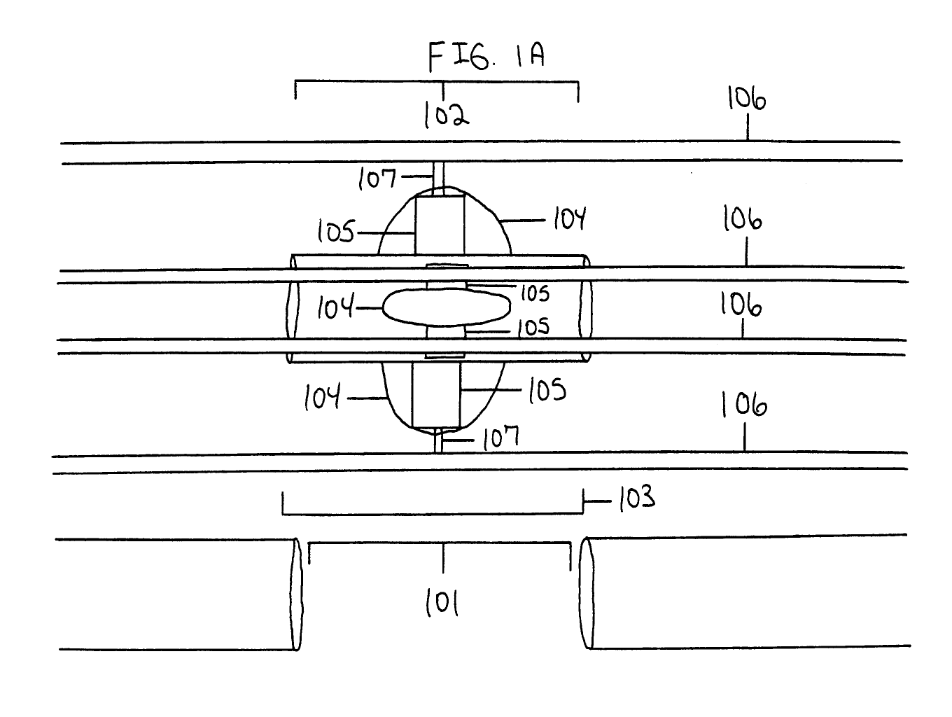

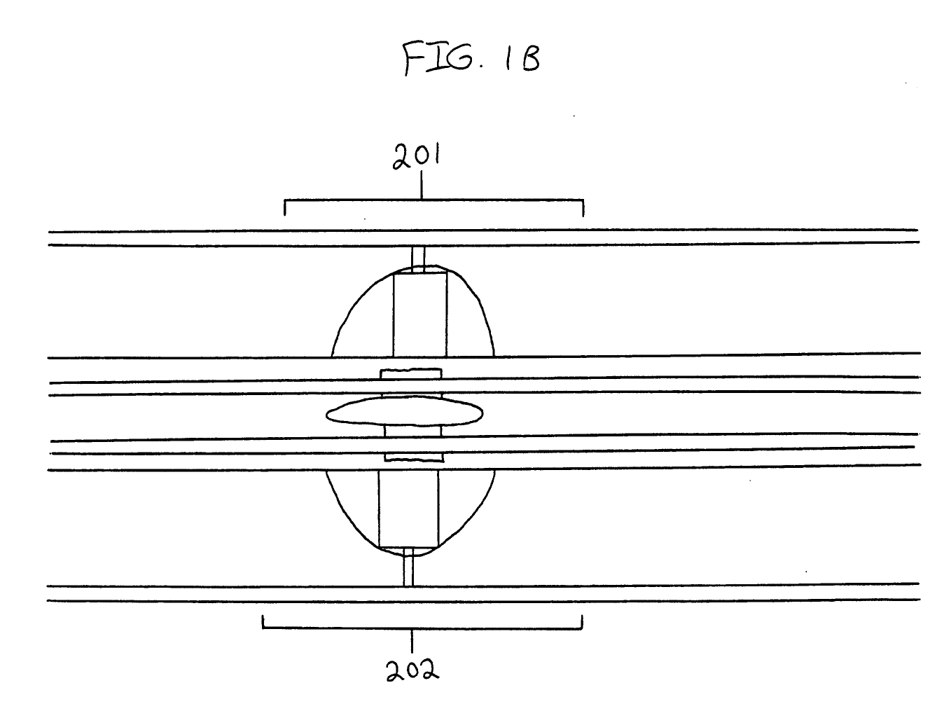

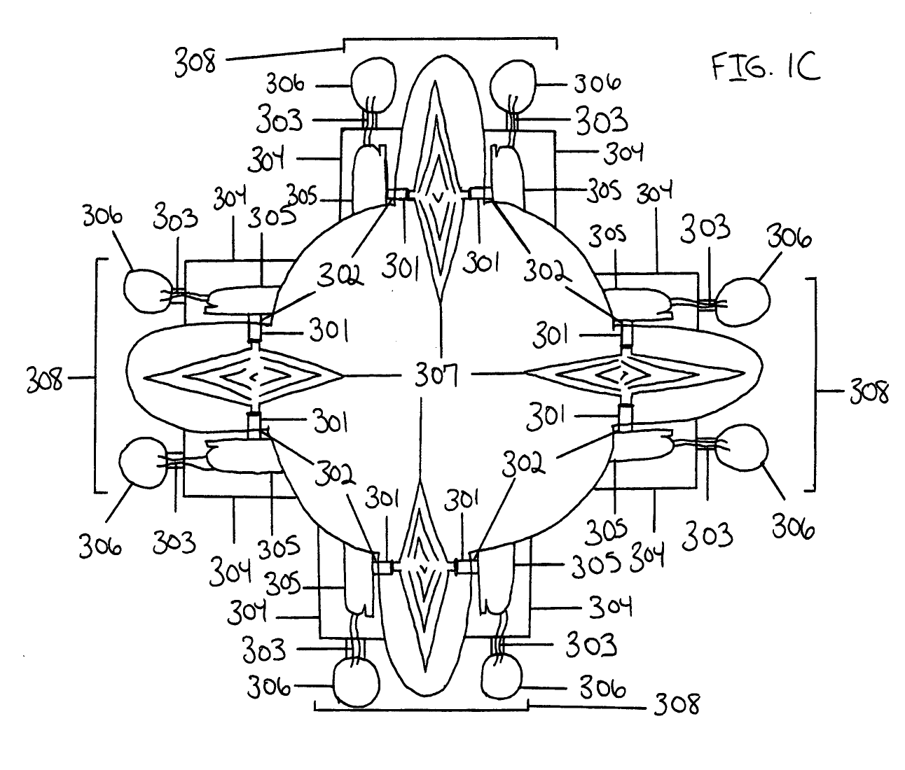

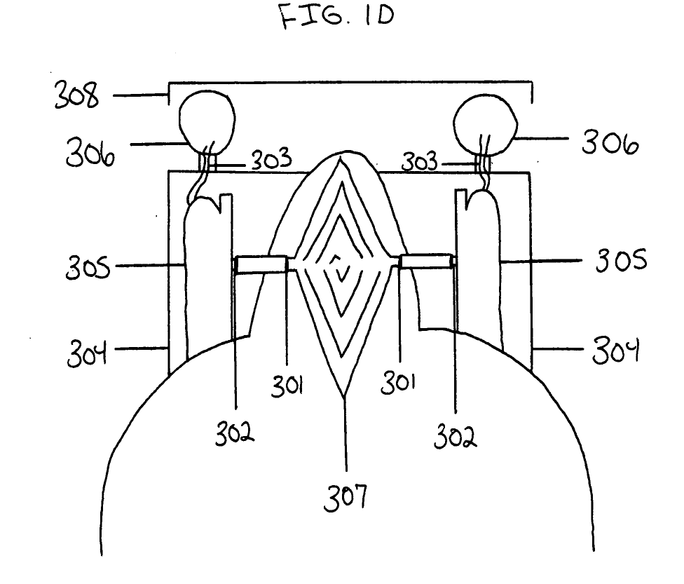

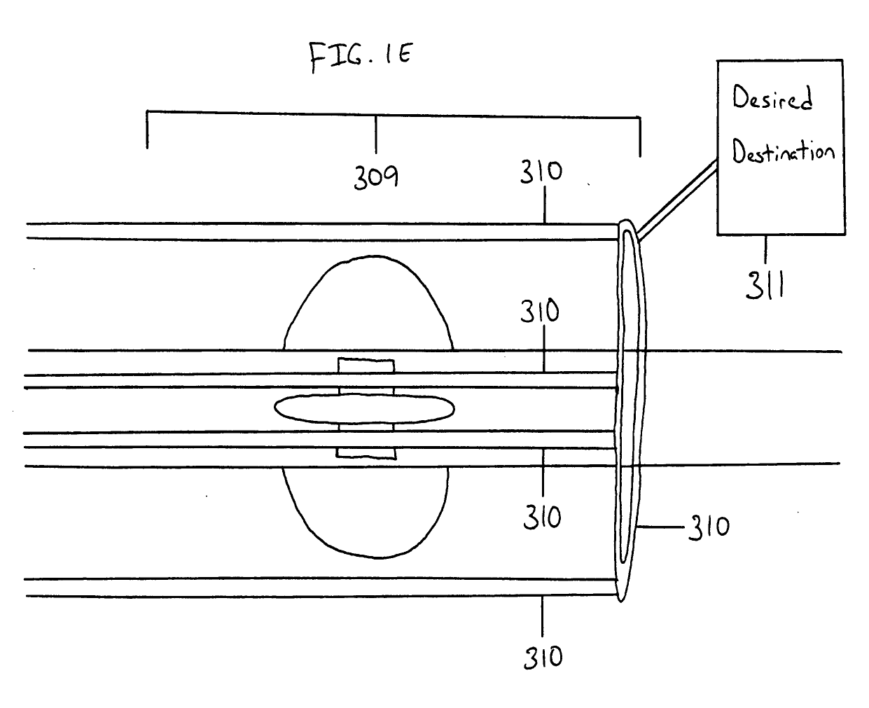

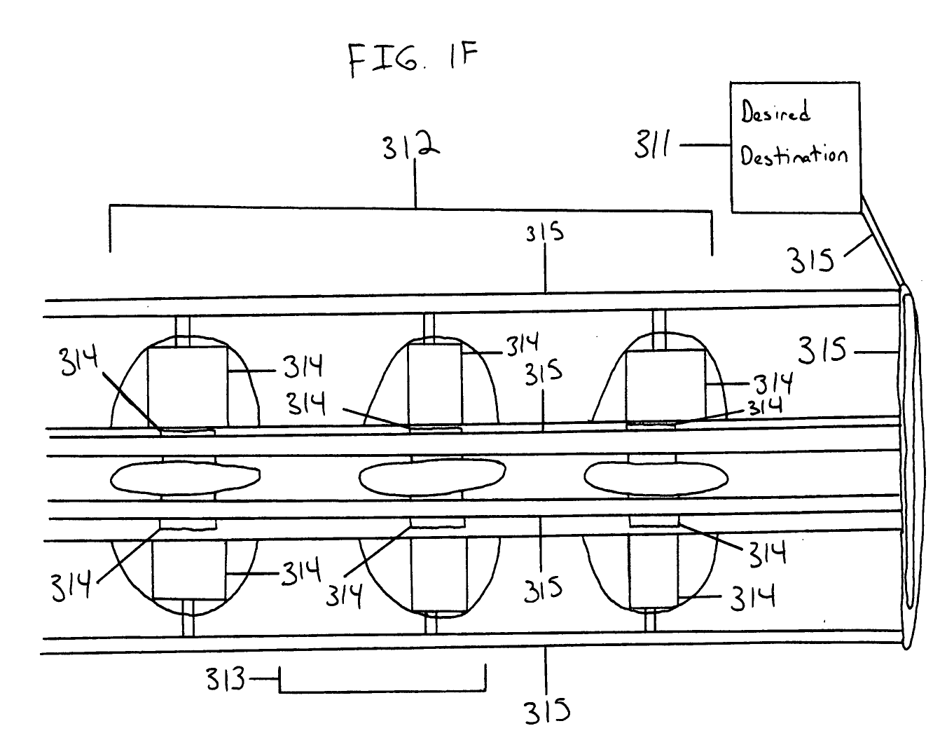

### Operation of Inventions—FIGS. 1A, 1B, 1C, 1D, 1E, 1F, 2A, 2B, 2C, 2D, 2E, 2F, 3A, 3B, 3C, 3D, AND 4

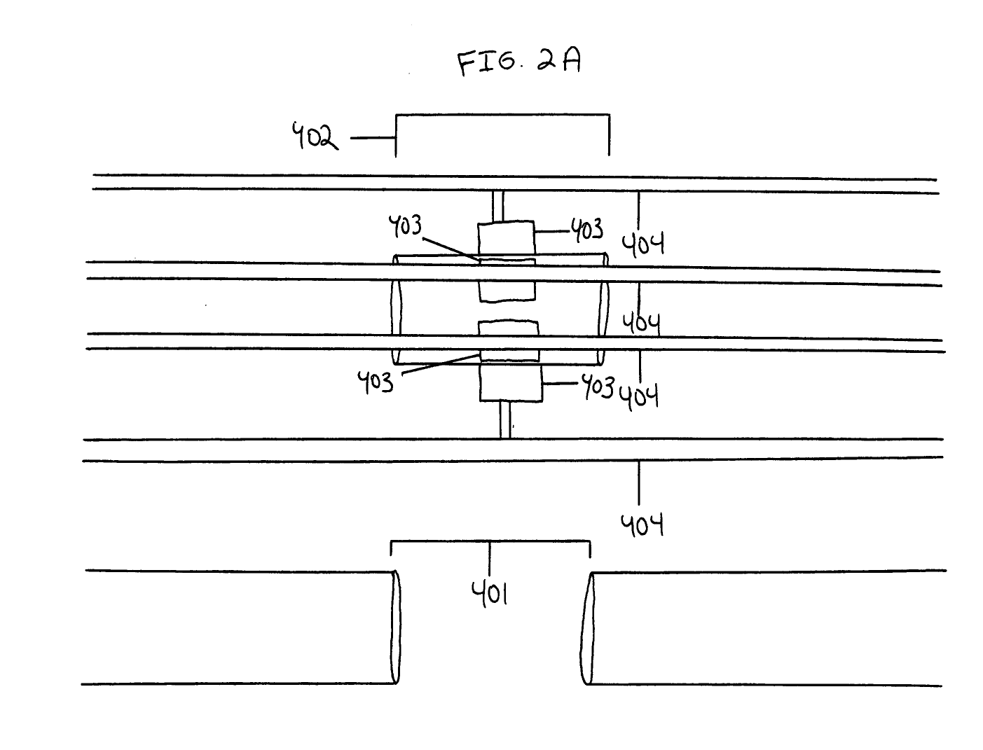

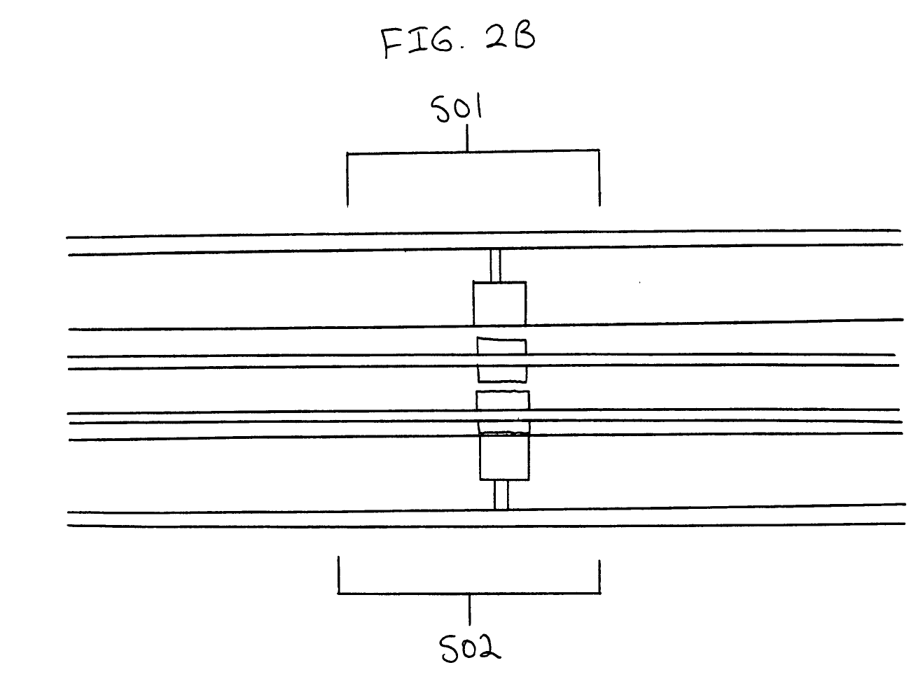

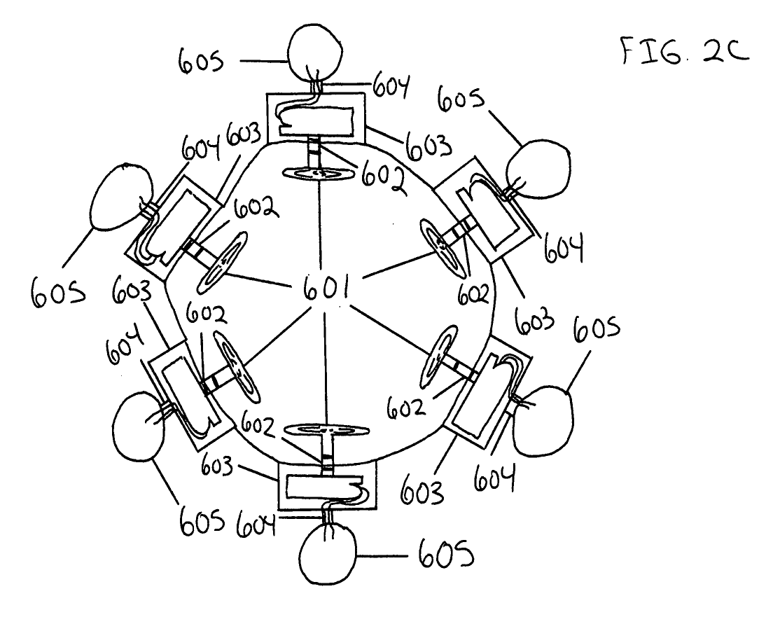

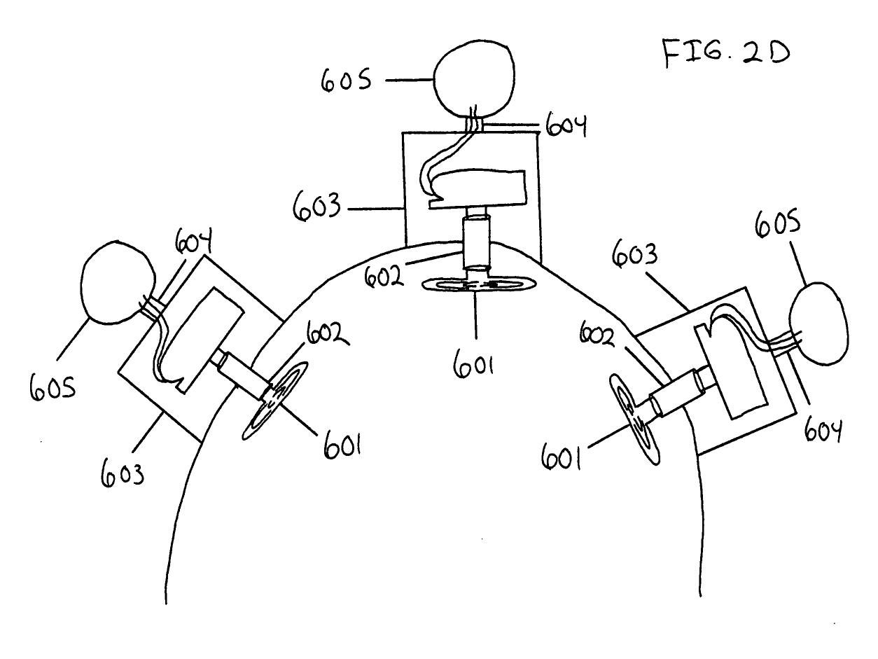

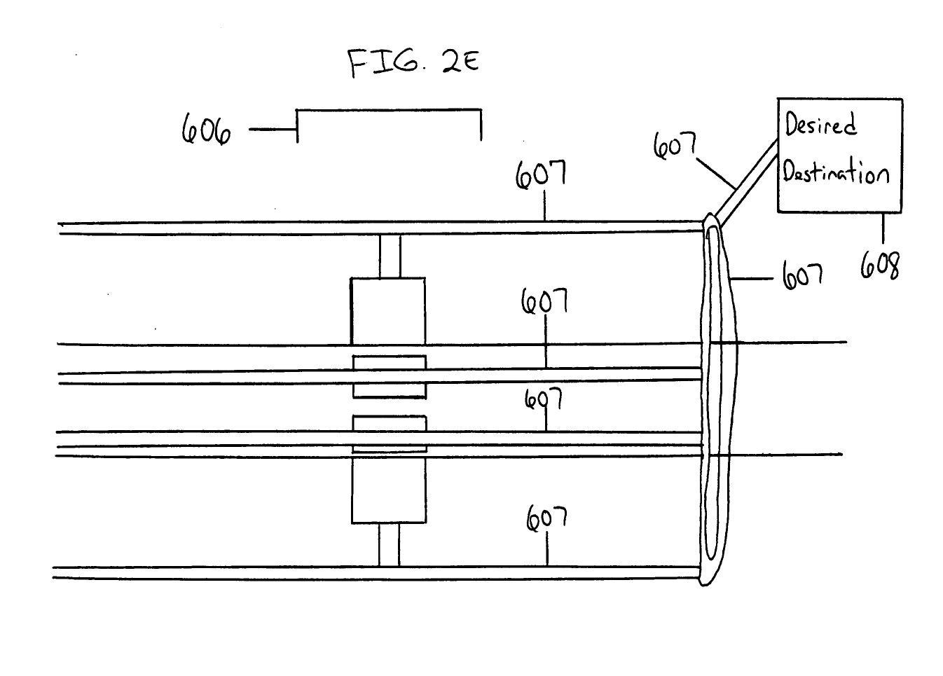

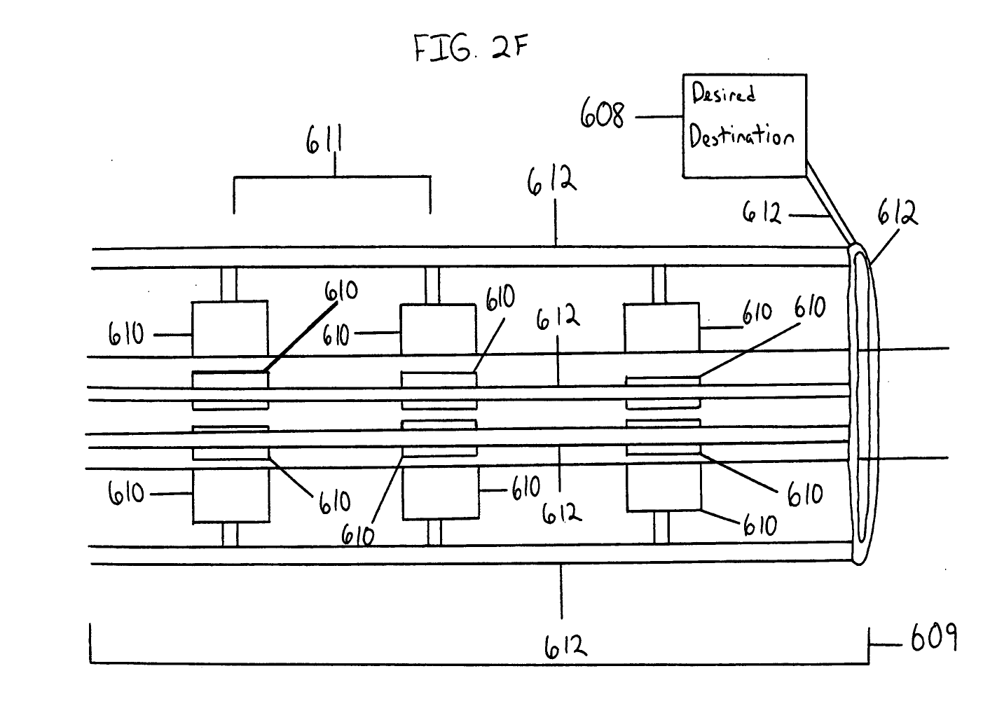

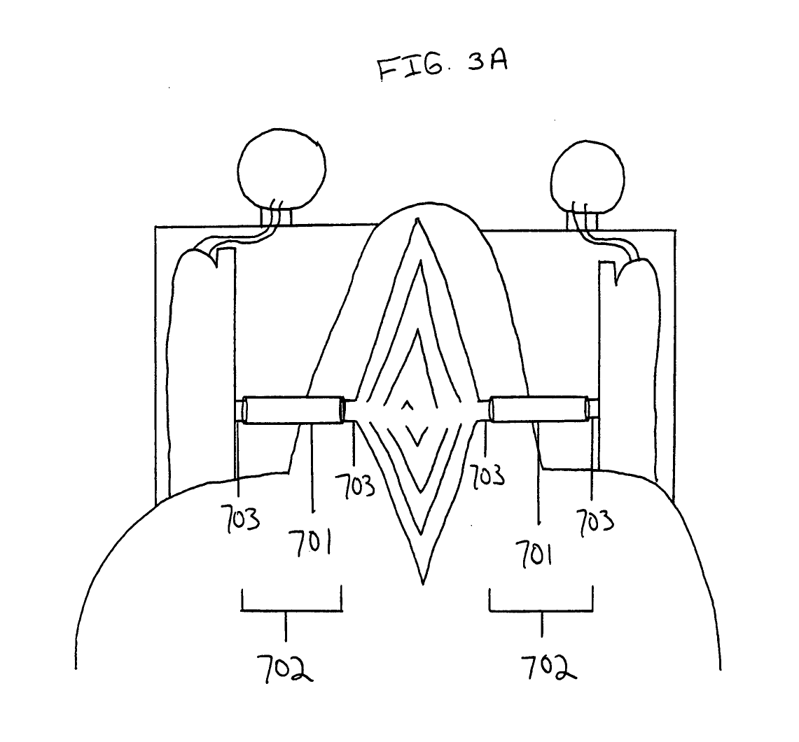

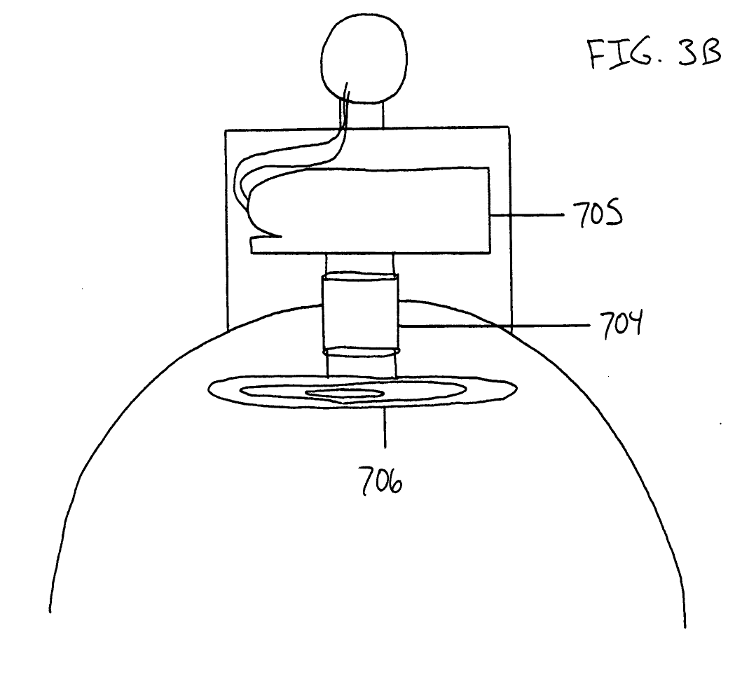

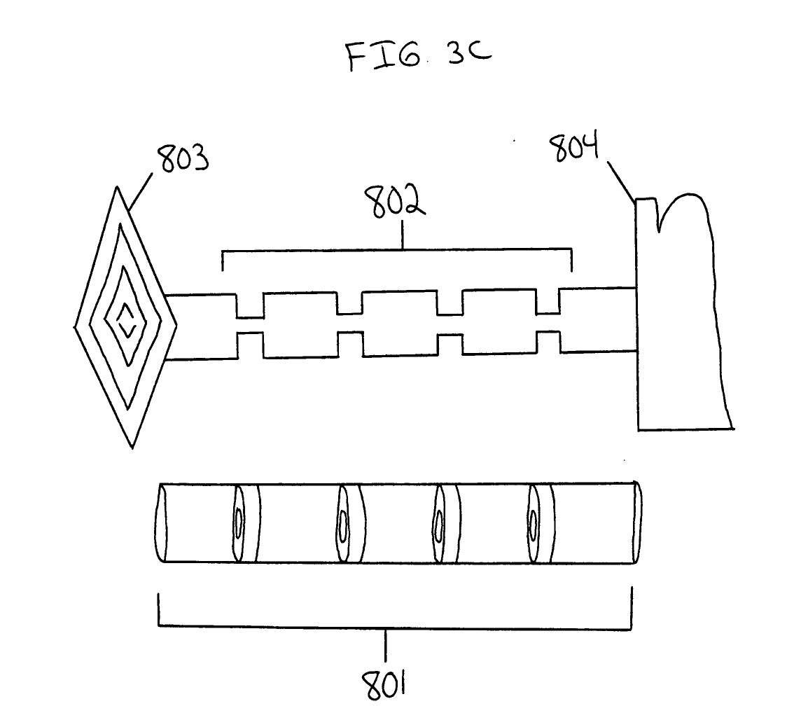

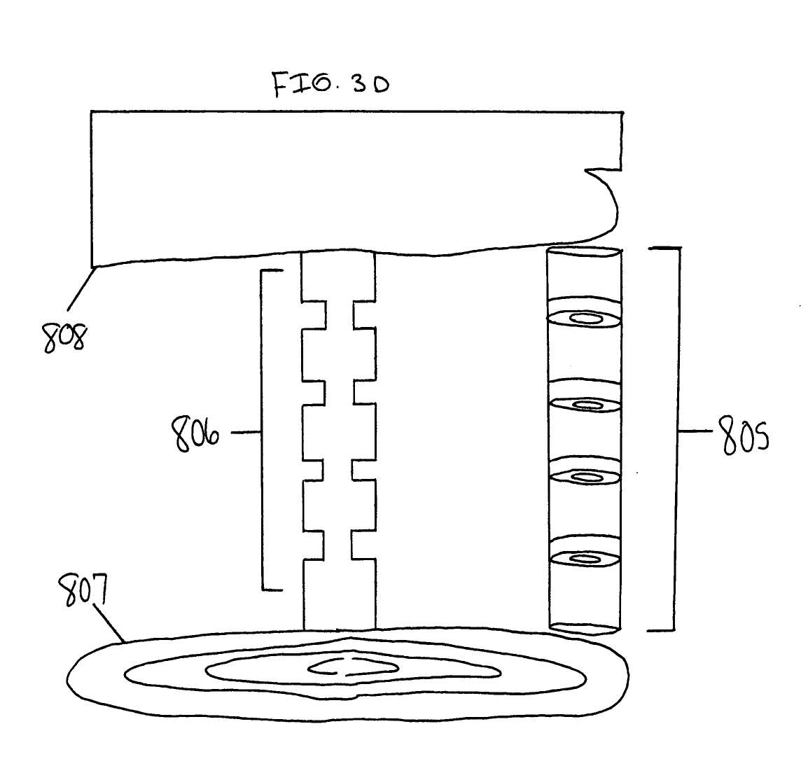

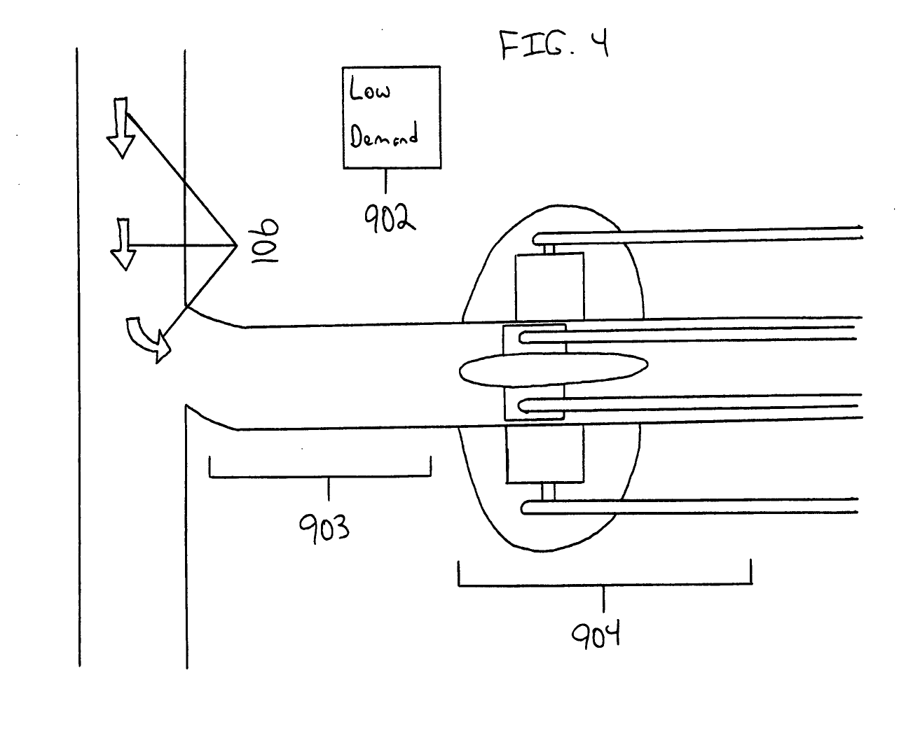

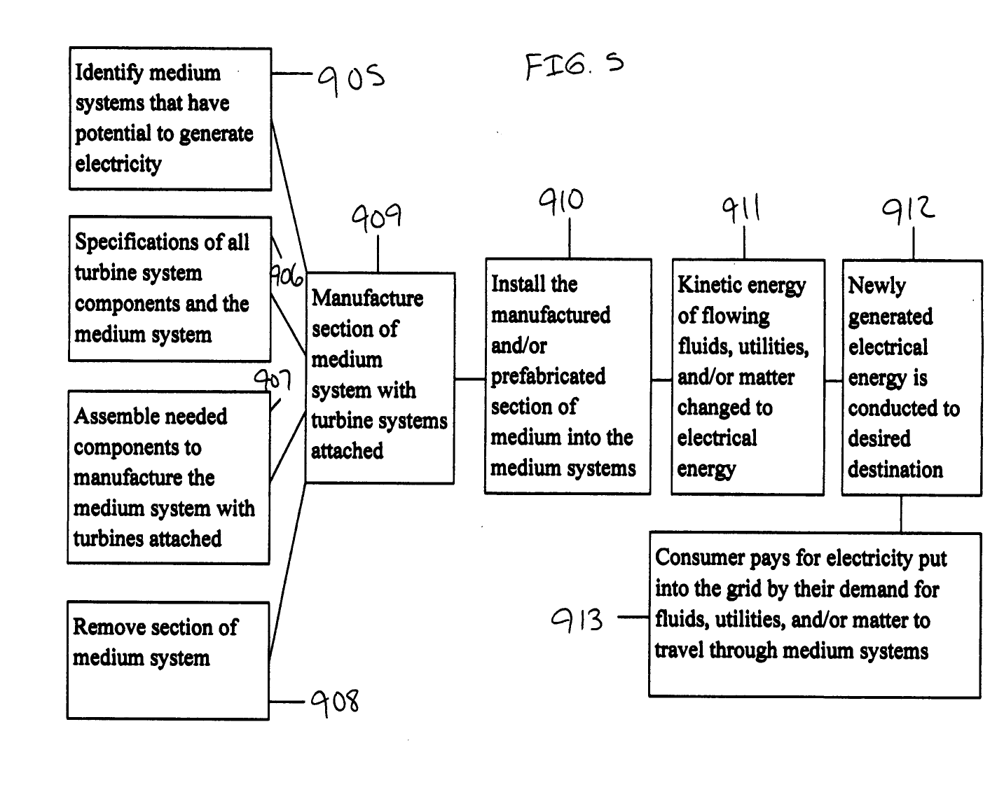

FIG. 1A. This figure depicts a section of a fluid-, utility-, and/or matter-carrying and/or encapsulated medium (101) that has been removed from a medium system and is being replaced with a prefabricated section of medium with turbine systems manufactured and attached to it (102). This prefabricated section will generate electricity by capturing the kinetic energy of fluids, utilities, and/or matter flowing through the medium and change it to electrical energy. This is a depiction looking from the side of the medium itself. One can see the design of using multiple turbines and multiple generators (103). This implementation of multiple turbine systems to a medium will maximize the amount of electricity that can be generated within a medium. The semicircular shapes on the top, bottom, and side of medium represent turbine housings that contain the turbines (104). These housings prevent fluids, utilities, and/or matter from escaping the medium and also house the turbine and mounting apparatuses. The square shapes on the sides of the turbine housings represent the generator housings that contain the generators (105). The kinetic energy is changed to electric energy by the turbine turning the generator by means of the turbine shaft. The generator housing holds the generator and allows for conduction wires that conduct the new electricity to travel to their desired destination. The mediums that are drawn above the generator housings represent the wire-carrying mediums that transport conduction wires to their desired destination (106). One can also see a small tube that projects from the roof of the generators housing that acts as a connection from the generator housings to the conduction pipes that allows the conduction wires to exit the generator housing and enter the conduction pipe (107).
FIG. 1B. This figure depicts the prefabricated section of medium with turbine systems manufactured and attached into it after it has been installed into the medium system (201). One can notice that the medium and the new section have been completely sealed off so that no fluids, utilities, and/or matter can escape (202).
FIG. 1C. This figure depicts the inside of the medium with the turbine systems attached. One can see how the turbines are supported and aligned with the generator by mounting apparatuses within the turbine housing (301). The mounting apparatus also is grooved along with the section of the turbine shaft that passes through it so that fluids, utilities, and/or matter cannot enter the generator housing. The mounting apparatus supports the turbine, aligns the turbine shaft with the generator, allows for the turbine shaft to enter the generator housing and attach to the generator, and does not allow anything to enter the generator housing. One can see how the turbine shaft is attached to the generator which will change the kinetic energy of the fluids, utilities, and/or matter to electrical energy by the turbine turning as the fluids, utilities, and/or matter impinge upon the turbine blades (302). One can also see the conduction wires which conduct the new electrical energy generated by the invention that are attached to the generator leaving the generator housing through the tube that connects the generator housing to the wire-carrying medium and allows the wire to enter the wire-carrying medium (303). One can see how the generator housings are attached to the sides of the turbine housings (304). The generator housing serves the purpose of containing the generator and should be located in reasonable proximity to the turbine housing. One can see the generators located inside of the generator housing (305). The generators change kinetic energy to electrical energy. One can also see the wire-carrying mediums attached to each generator housing that will allow the conduction wires to travel to their desired destination (306). One can see how the turbine blades protrude into the medium where fluids, utilities, and/or matter will impinge upon them and make them turn (307). One can also see how one turbine can be linked to two generators therefore allowing the kinetic energy inside of the medium to generate twice as much electrical energy (308). There are four turbines and eight generators in the depiction which shows that electrical generation potential is maximized by using multiple turbine systems attached to a prefabricated section of a pressurized/non-pressurized fluid-, utility-, and/or matter-carrying medium.
FIG. 1D. This figure is a depiction of each turbine system attached to a medium with more of an up-close view (301-308).
FIG. 1E. This figure depicts the prefabricated section of medium being installed in isolation or at longer intervals along a medium system (309). One can see that the wire-carrying mediums (310), eight in all (six that one can see and two that are on the opposite side of the medium), will transport conduction wires from the eight generators to their desired destination, whatever destination that may be (311).
FIG. 1F. This figure depicts prefabricated sections of medium being installed in groups or at much shorter intervals along the entirety of a medium system (312). One can see how the eight wire-carrying mediums carrying the conduction wires are connected from prefabricated section to prefabricated section (313). This connection serves the purpose of being able to transport many conduction wires which will be coming from many prefabricated sections of mediums with turbine systems attached all along the entirety of a pressurized/non-pressurized fluid-, utility-, and/or matter-carrying and/or encapsulated medium system. There are 24 generators in all (314) and the wire-carrying mediums (315, six that one can see and two more on the opposite side of the medium) transport the conduction wires from each generator to their desired destination, whatever destination that may be (311).
FIG. 2A. This figure depicts a section of a pressurized/non-pressurized fluid-, utility-, and/or matter-carrying and/or encapsulated medium that has been removed from a medium system (401) and is being replaced with a prefabricated section of medium with turbine systems manufactured and attached to it (402). This is a depiction looking from the side of the medium itself. One can see several generator housings attached to the prefabricated section of medium (403) with wire-carrying mediums attached to the roof of each generator housing (404).
FIG. 2B. This figure depicts a section of a fluid-, utility-, and/or matter-carrying and/or encapsulated medium that has been removed from a medium system and is being replaced with a prefabricated section of medium with turbine systems manufactured and attached to it (501). This is a depiction looking from the side of the medium itself. One can see that the medium and the newly installed prefabricated section of medium have been completely sealed off so that no fluids, utilities, and/or matter can escape the medium (502).
FIG. 2C. This figure depicts the inside of the medium with turbines manufactured inside of the medium itself. One can see how the turbines are located inside of the medium (601) and how they are supported and aligned by the mounting apparatus (602). One can see six generator housings attached to the outside of the medium with generators inside (603). One can also see the tube (604) that connects the generator housing to the wire-carrying medium and allows the conduction wires to leave the generator housing and enter the wire-carrying medium (605).
FIG. 2D. This figure is a depiction of each turbine system attached to a medium with more of an up-close view (601-605).
FIG. 2E. This figure depicts the prefabricated section of medium being installed in isolation or at longer intervals along a medium system (606). One can see how the wire-carrying mediums (607) transport the conductions wires to their desired destination, whatever that desired destination may be (608).
FIG. 2F. This figure depicts prefabricated sections of medium being installed in groups or at much shorter intervals along the entirety of a medium system (609). One can see the generator housings (generators are inside of the generator housings), 18 in all, attached to the sides of the medium (610, there are 12 one can see and six on the opposite side of the medium) and how the wire-carrying mediums are connected from prefabricated section to prefabricated section (611). One can also see the wire-carrying mediums transporting the conduction wires to their desired destination (612, there are four that one can see and two located on the opposite side of the medium).
FIG. 3A. This figure is meant to give a better depiction of the mounting apparatuses (701) and how they allow for the turbine shaft to be supported and aligned with the generator (702) so that the turbine shaft can be connected to the generator (703). This is a critical aspect of changing the kinetic energy of flowing fluids, utilities, and/or matter to electrical energy.
FIG. 3B. This figure is meant to give a better depiction of the mounting apparatus for the design of placing turbines entirely inside of a medium. One can see how the mounting apparatus (704) both supports and aligns the turbine shaft to the generator in the generator housing located outside of the medium (705). Also, once can see how the turbine blades are designed with empty space in the blades to reduce the amount of pressure or head that could possibly be lost within the medium (706).
FIG. 3C. This figure gives a depiction of how the inside of the mounting apparatus is grooved (801) as well as the part of the turbine shaft that passes through the mounting apparatus is grooved (802). This is an important part of the design because fluids, utilities, and/or matter must not be allowed to enter the generator housing. One can see the turbine on the left side of the figure (803), the grooved turbine (802) shaft that connects to the generator on the right side of the figure (804), and below the grooved turbine shaft how the mounting apparatus is grooved (801) to match the dimensions of the turbine shaft so that it can connect to the generator and not allow fluids, utilities, and/or matter to enter the generator housing.
FIG. 3D. This figure gives a depiction of how the inside of the mounting apparatus is grooved (805) as well as the part of the turbine shaft that passes through the mounting apparatus is grooved (806) when turbines are located completely inside of the medium. One can see the turbine at the top of the figure (807), the grooved turbine shaft (806) that connects to the generator at the bottom of the figure (808), and to the left of the turbine shaft how the mounting apparatus is grooved to match the dimensions of the turbine shaft (805).
FIG. 4. This figure is a depiction of how this technology could be utilized when demand is low for pressurized/non-pressurized utilities, fluids, and/or matter to travel from one place to another. One can see how utilities, fluids, and/or matter traveling through a medium system in the direction that the arrow is pointing (901). The words “low demand” (902) mean that peak periods of use have past but there are excess fluids, utilities, and/or matter that is pressurized/non-pressurized that still have the potential to generate electricity. These utilities, fluids, and/or matter are rerouted (903) to a medium system with the new technology attached that is designed to capture the kinetic energy of said fluids, utilities, and/or matter even in periods of low demand (904).
FIG. 5. This figure is a depiction of a flowchart for implementing the process into a medium system. First, a medium system(s) is identified that can potentially generate electricity (905). Then, the specifications of all turbine system components and medium system(s) components are identified (906) and all components are assembled to manufacture a section of medium that meets all aforementioned specifications (907). Next, a section of a medium is removed (908), the new section is manufactured (909), and then the new section is installed (910) into the medium system(s). The kinetic energy of the flowing fluids, utilities, and/or matter is harnessed by the turbine system and changed to electrical energy (911), conducted to a desired destination (912), and consumers pay for electricity created by their demand for fluids, utilities, and/or matter to travel in medium systems (913).

### CONCLUSION, SCOPE OF INVENTION, AND RAMIFICATIONS

While the above description contains many specificities, these should not be construed as limitations on the scope of the invention, but rather as an exemplification of one preferred embodiment thereof. There are many different types of turbines, turbine blades, generators, electrical wires, desired destinations, turbine shafts, mounting apparatuses that can be utilized to generate electricity and each can be manufactured and installed in a myriad of existing and yet to be discovered fashions. There are other types of medium systems that the process could be utilized with. There are many different ways to prefabricate a section of fluid-, utility-, and/or matter-carrying medium using many different materials and composites. Turbines can be attached and manufactured to varying degrees within a medium system. There are several possible ways for routing fluids, utilities, and/or matter in medium systems during periods of low demand. There are many different ways to limit the amount of potential pressure or head lost while using the above stated process. There are many different ways to manufacture a turbine housing, generator housing, and wire-carrying medium. There are many different desired destinations that the newly generated electricity could be conducted to in any geographical area and/or power grid. There are many different types of fluids, utilities, and/or matter that flow through medium systems that can be utilized to generate electricity.

I claim:

1. A process for installing prefabricated sections of pressurized and/or non-pressurized fluid-, utility-, and/or matter-carrying or encapsulated medium systems with turbine systems attached that comprises:
Removing a section of an existing fluid-, utility-, and/or matter-carrying or encapsulated medium system;
Prefabricating a section of fluid-, utility-, and/or matter-carrying or encapsulated medium system with turbine systems attached;
Installing the prefabricated section of fluid-, utility-, and/or matter-carrying or encapsulated medium system into the medium system;
Harnessing the kinetic energy of flowing fluids, utilities, and/or matter through medium systems by said fluids, utilities, and/or matter impinging upon turbine blades;
Changing the kinetic energy into electrical energy by means of a generator;
Conducting the newly generated electrical energy to a desired destination by wires;
Rerouting fluids, utilities, and/or matter during periods of low demand into medium systems with turbine systems attached;

2. A process in claim 1 wherein a section of an existing fluid-, utility-, and/or matter-carrying medium or encapsulated medium will be removed via any existing or yet to be discovered process.

3. A process in claim 1 wherein a section of a fluid-, utility-, and/or matter-carrying medium or encapsulated medium will be manufactured with turbine systems attached.

4. A process in claim 3 wherein the turbine systems will include a turbine, turbine blades, a turbine shaft, mounting and aligning apparatuses, a turbine housing, a generator, a generator housing, a tube, conduction wires, and a wire-carrying medium.

5. A process in claim 3 wherein several turbine systems can be manufactured into the section of fluid-, utility-, and/or matter-carrying medium or encapsulated medium along the circumference, outer wall, and/or inner wall of the medium.

6. A process in claim 3 wherein the manufacturing of sections of medium systems with turbines attached will vary according to the specifications of the medium systems and the potential amount of electrical energy that can be generated.

7. A process in claim 1 wherein the manufactured and/or prefabricated section of fluid-, utility-, and/or matter-carrying medium or encapsulated medium will be installed into a medium system and sealed using any existing or yet to be discovered process in either isolation or in groups along the entirety of a medium system.

8. A process in claim 1 wherein flowing fluids, utilities, and/or matter will impinge upon the blades of the turbine causing it to turn and thus harnessing the kinetic energy of the flowing fluids, utilities, and/or matter.

9. A process in claim 8 wherein the turbine will be contained in a turbine housing.

10. A process in claim 8 wherein the impinging upon of the turbine blades by the flowing fluids, utilities, and/or matter will cause the turbine shaft to turn.

11. A process in claim 9 wherein the turbine shaft will be mounted and aligned by mounting apparatuses within the turbine housing that allow for the turbine shaft to be connected to a generator.

12. A process in claim 11 wherein the mounting apparatuses and turbine shaft will be grooved and/or sealed so that fluids, utilities, and/or matter will not be able to enter the generator housing.

13. A process in claim 8 wherein the turning of the turbine shaft that is connected to a generator will change the kinetic energy of the flowing fluids, utilities, and/or matter into electrical energy.

14. A process in claim 13 wherein the newly generated electrical energy will be conducted from the generator to a desired destination via conduction wires that are attached to a generator.

15. A process in claim 14 wherein the conduction wires will be contained and transported to the desired destination within a wire-carrying medium.

16. A process in claim 3 wherein the turbine systems can be manufactured to attach to one generator or several generators.

17. A process in claim 3 wherein the generator(s) will be contained in a generator housing.

18. A process in claim 1 wherein during periods of low consumer demand for fluids, utilities, and/or matter to flow through medium systems, excess fluids, utilities, and/or matter will be rerouted into medium systems that have turbine systems attached to harness the kinetic energy of the flowing fluids, utilities, and/or matter.

19. A process in claim 1 wherein consumer demand for fluids, utilities, and/or matter to flow through fluid-, utility-, and/or matter-carrying medium systems will generate electrical energy that can be put back into the power grid.

20. A process in claim 1 wherein an entire fluid-, utility-, and/or matter-carrying medium system with turbine systems attached could replace an existing medium system or be implemented into yet to be discovered or created systems.
